(19) United States
(12) Patent Application Publication
(10) Pub. No.: US 2002/0004759 A1
(43) Pub. Date: Jan. 10, 2002

(54) Method and apparatus for electronic barter system

(76) Inventors: Kevin B. Bradford, Scottsdale, AZ (US); Eric Gertler, New York, NY (US); James D. Kunkel, Half Moon Bay, CA (US); Bippy Siegal, San Francisco, CA (US)

Correspondence Address: WILSON SONSINI GOODRICH & ROSATI, 650 PAGE MILL ROAD, PALO ALTO, CA, 943041050

(21) Appl. No.: 09/848,775

(22) Filed: May 4, 2001

Related U.S. Application Data
(63) Continuation-in-part of application No. 09/587,579, filed on Jun. 1, 2000.
(60) Provisional application No. 60/137,311, filed on Jun. 3, 1999.

(51) Int. Cl. G06F 17/60

(52) U.S. Cl. 705/26

(57) ABSTRACT

Electronic bartering systems and methods are described. Methods are described for completing a transaction by use of a national currency and a mutual currency. Items offered on the system may be classified as for barter or reward. In embodiments, an item offered on the system may have a listing price ($P) specified in the national currency and a minimum amount of national currency desired by the seller ($X) specified in the national currency. In some embodiments, the system has a maximum barter to cash ratio (%C) such that the item is classified for reward if $X/$P>%C.

### RELATED APPLICATIONS

This application relates to, claims the benefit of, and incorporates by reference the U.S. application No. 09/587,579 entitled “Electronic Barter Method and Apparatus,” inventors Eric Gertler and Bippy Segal, filed Jun. 1, 2000, and U.S. provisional patent 60/137,311, entitled “Electronic Barter Method and Apparatus,” inventors Eric Gertler and Bippy Segal, filed Jun. 3, 1999, both of which are hereby incorporated by reference in their entirety.

### BACKGROUND OF THE INVENTION

1. Field of the Invention

This invention relates to the field of barter systems. In particular, the invention relates to electronically enabled barter systems allowing for the creation of an alternative economy through the web.

2. Description of the Related Art

1. Barter and Mutual Currencies

Bartering is considered one of the earliest forms of exchange, which according to some economists was superceded due to the higher efficiency of cash. However, other economists believe that view is overstated. Further, barter systems can continue to play a valuable role in coexistence with regular currencies.

Several companies the world over act as various types of barter exchanges. These exchanges typically overcome one problem associated with traditional barter, the need for buyers and sellers to be directly paired. For example, if John wants to buy food and has clothing to sell, in a traditional barter system, he might need to make several intermediate trades to get the baskets that the food seller wants in return for food. In contrast, in hybrid barter systems, a mutual currency is selected such as a trading unit, a trading dollar, a trading credit, etc.

Unlike national currencies, trading credits do not need to be centrally created. Instead, participants mutually create the currency through the transaction process. The availability of participants in the trading exchange to accept the trading credit for their goods creates the value. Thus, trading credits are created with transactions as a corresponding credit and debit on the participants' accounts. Thus, the value of the trading credit will vary appropriately with the local economy and may in fact be more robust than national currencies experiencing financial austerity, inflation, and/or other crises.

Some trading units are linked to a national currency such as the United States Dollar, the Euro, etc., for reference purposes. This may be convenient for pricing and conversion purposes. However, it may cause some instability if the reference currency experiences crises.

2. Barter Exchanges

These mutual currencies are typically combined in off-line trading exchanges. For example, Active International, Pearl River, N.Y., <http://www.activeinternational.com>, provides barter services using trade credits as a type of mutual currency. Typically, Active International “purchases an under-performing inventory slated for liquidation for full wholesale value, in exchange for cash and Active Trade Credits. The inventory is re-marketed in eastern Europe, outside its normal distribution channel. The Trade Credits are then used to reduce the cash required to purchase pre-planned media or other business services at benchmark prices where active holds capacity positions or through the vendor linking program.” (See <http://www.activeinternationl.com/barter.htm>, emphasis added)

Like most barter exchanges that provide liquidation services for business to business exchanges, Active International takes legal possession of the bartered goods by purchasing them. This requires the barter exchange to also act as sales people and identify outlets for the goods and services. Further, the barter companies maintain an inventory of services to be used by clients, e.g. media advertising space, travel services. These goods and services are characterized by their ability to be bought at a discount because of high fixed costs and low marginal costs, etc. Thus, the barter exchange is required to maintain two types of inventory: inventory from its sellers and inventory for its sellers, as buyers of services in trading credits.

For businesses, the barter deals can function as alternatives to off-balance-sheet financing. The difference between the liquidation value of the excess inventory and the cash cost of the purchased service, e.g. advertising space, add significant economic value. However, barter deals are typically carried on balance sheets as pre-paid purchases.

Other companies such as BarterCard, Queensland, Australia, <http://www.bartercard.com.au/>, offer a point of sale type card to allow participating members to access their barter exchange trade credits, called trade dollars in the BarterCard system, from points of sale (POS) in retail and service establishments. Thus, for example, if John is a member of BarterCard and he takes his car to Jane's Auto Repair center, a company that participates with BarterCard, then John can use his BarterCard at Jane's store to complete the purchase. Jane can in turn spend her trade credits with other BarterCard members.

This approach makes BarterCard more like a bank than a traditional barter exchange; although, it may serve to reduce the usefulness of the service for business to business exchanges. Specifically, BarterCard is not required to maintain inventory; however, BarterCard type systems may not be able to support the type of merchandise liquidation that traditional barter houses provide.

### SUMMARY OF THE INVENTION

The invention includes a system and method for completing transactions by use of national currencies and one or more mutual currencies; in embodiments of the invention, these mutual currencies may take the form of credits in an online barter system which may be redeemed for goods and services offered on the online system.

Embodiments of the invention include software resources for classifying items offered on the system as either for barter or reward. If the item is for barter, the online system may be used to transfer a first predetermined amount of the national currency from the buyer to the seller of the item and a second predetermined amount of the mutual currency from the buyer to the seller of the item. If the item is for reward, the online system may be used to transfer a third predetermined amount of national currency from the buyer to the seller of the item and a fourth predetermined amount of mutual currency from the seller of the item to the buyer.

In embodiments of the invention, an item offered on the system may have a listing price ($P) specified in the national currency and a minimum amount of national currency desired by the seller ($X) specified in the national currency. In some embodiments, the system has a maximum barter to cash ratio (%C) such that the item is classified for reward if $X/$P>%C.

Embodiments of the invention may an exchange ratio (r) between the national currency and the mutual currency. In some embodiments if an item has been classified for reward, a historical data, an available mutual currency balance of the seller, and a line of credit in the mutual currency of the seller are used to select the fourth predetermined amount (#R) so as to globally minimize the available mutual currency balance of the seller and the line of credit in the mutual currency of the seller over a predetermined period. These and other embodiments are described in greater detail infra.

### BRIEF DESCRIPTION OF THE FIGURES

FIG. 1 illustrates a computer implementing one embodiment of the invention.

FIG. 2 is a flowchart describing the process for classifying inventory as barter or reward transactions.

FIG. 3 is a flowchart describing the inventory availability process provided to buyers using the barter system.

### DETAILED DESCRIPTION

A. System Overview

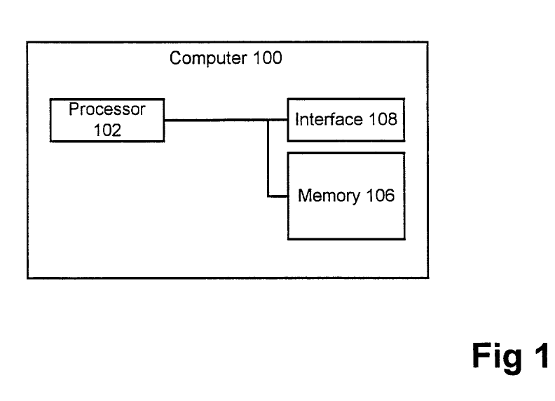

FIG. 1 illustrates a computer implementing one embodiment of the invention. Such a computer can be used to store details about the inventory as described below and provide the improved barter system supporting rewards.

The following describes the elements of FIG. 1 and their interconnections. FIG. 1 includes a computer 100. The computer 100 includes a processor 102, a memory 106, and an interface 108. The processor 102, the memory 106 and the interface 108 are coupled in communication.

The following describes the uses of the elements of FIG. 1. The computer 100 will typically be a high-end computer such as a server, a workstation, a super-computer, and/or some other type of computer. Although only a single computer is shown, the computer 100 may be comprised of a cluster of computers operating in conjunction with one another.

The processor 102 may include one or more processors such as Alpha™ AXP series processors, Intel Pentium™ series processors, PowerPC™ series processors, and/or other types of processors. The processor 102 is capable of running the indexing and searching procedures described below.

The memory 106 provides storage for programs and/or data on the computer 100. For example, the memory 106 might include the cache memory of the processor 102; the random access memory (RAM) of the computer, hard drive memory storage, and/or some other type of storage. In some instances, the memory 106 may be physically external to the computer 100, while still coupled in communication with the computer, e.g. fiber-channel disk array coupled to the computer 100.

The interface 108 provides one or more connections between the computer 100 and other computers. For example, the interface 108 might support a high-speed network connection such as fiber or Ethernet. The particular interface can be adapted for the demands on the computer 100. Also, if the computer 100 is comprised of a cluster of computers, the interface 108 may be used for communication between the computers.

In typical embodiments, the inventory information and/or mutual currency balances for participants is/are stored in the memory 106. Another computer can query the computer 100 by sending one or more messages over the interface 108. The messages may be in a proprietary format and/or a standard query format, e.g. SQL, ODBC, etc. Alternatively, the computer 100 may provide a web server to directly respond to query requests received over the interface 108 directly from end users with a common gateway interface (CGI) script, or other program.

Now, the barter and reward system used by embodiments of the invention will be described.

B. Barter System with Rewards for Profit Maximization

1. Introduction

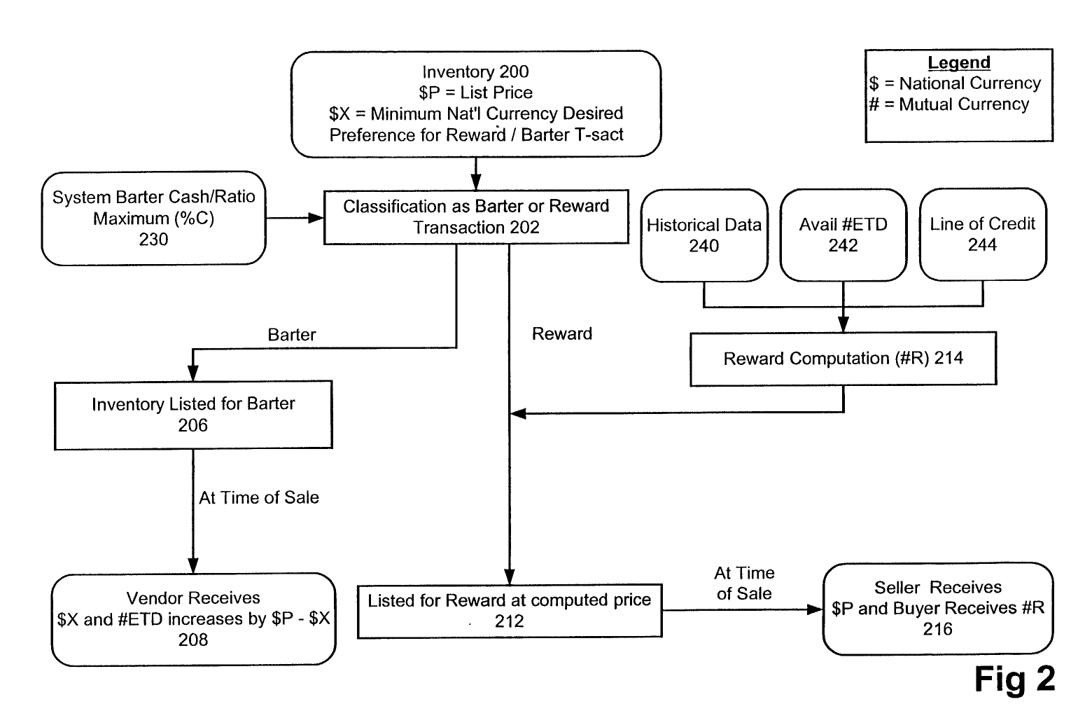

First, the notation used throughout the remainder of the discussion, and in FIG. 2, will be discussed. Then the purpose of the reward system integration with a barter economy will then be described. Finally, the process used by embodiments of the invention to conduct barter transactions will be discussed.

2. Notation

For convenience, the national currency will be indicated with a dollar sign ($) in front of the number or letter, e.g. $10.59 or $P. This indicates that the value is in a national currency and/or paid in the same. Similarly, the mutual currency will be indicated with a pound symbol (#) in front of the number or letter, e.g. #573 or #R. This indicates that the value is in the mutual currency and/or will be paid in the same.

3. Purpose

Jump starting a barter system requires significant effort on the part of the barter system operator and remains a difficult task. One important task is the identification of initial participants with large quantities of inventory to barter. However, for a variety of reasons, those initial participants may not desire to receive much, or any, of the mutual currency.

Although the following discussion is phrased in terms of initial participants, the system may be employed generally by the barter system operator on a per participant basis at any time. Many of the benefits of the system are more pronounced in the early formation of the barter economy.

Two particular reasons, or fears, that the initial participants may have against holding the mutual currency are that they will be stuck with the mutual currency and/or that taxation issues will be complicated. For example, if the barter system operator signs up a hotel chain as an initial partner, that hotel chain operator may be afraid of accumulating large sums of the mutual currency with nowhere to spend it. Similarly, if they hold the mutual currency across tax years, there may be adverse, or complicated, tax consequences. For example, they may be required to pay a tax in the national currency on the held over mutual currency balance.

Therefore, a reward system is developed to integrate with a barter system. The reward system allows for consumption of participant earned mutual currency balances. Specifically, mutual currency balances, e.g. #ETD, for a participant, can be paid out to purchasers of inventory selectively. A comparison with other barter models may be clarifying:

(a) Simple Mutual Currency Barter: Selling participant gets #X for her/his goods from buyer's account of the mutual currency.

(b) Hybrid Mutual Currency Barter: Selling participant gets a mixture of national currency $Y and the mutual currency #X for her/his goods from the buyer.

(c) Reward Mutual Currency Barter: Selling participant gets national currency only $Y from the buyer, buyer receives a reward in the mutual currency #X from the seller.

Thus, if the system optimizes the allocation of an initial participant's mutual currency balance by allowing for reward mutual currency barter as needed, the initial participant can avoid the accumulation of mutual currency.

Other benefits include: automated—and economically sound—solution to concerns of initial partners; creates buyer-driven demand for uses for the mutual currency; and ignites the economy of the barter system by injecting the mutual currency—thus reducing reliance on “buying” into the mutual currency and seller-based transactions to stimulate the economy.

The system also increases flexibility for initial participants by allowing them to differentiate the inventory listed on the barter system. They can then provide a mixture of prime, national currency priced, inventory and excess, barter/hybrid barter, inventory. Thus, initial participants can attract both cash paying customers and eliminate excess inventory.

Furthermore, the barter system can steer purchasing participants to appropriate inventory categories based on screening questions. For example, “Seeking lowest price?”, “Highest Availability Required?”, “Restrictions Accepted?”, etc., as appropriate for the type of good sold. Thus, the initial participant can initially direct the purchasing participant to either their excess inventory or their prime inventory.

Additionally, if desired the barter system operator—or a third party working with the same—can offer lines of credit in the mutual currency for providing rewards. This supports the initial phases of the creation of the barter economy most strongly because it allows the initial partners to quickly move their prime inventory when they may not yet have sufficient balances of the mutual currency. The preferred interest rate used by embodiments of the invention is 2% with declining tiers to 0.5% based on the size of the outstanding balance. Notably, the interest stream can supply an additional revenue stream to the barter system operator, or their partner.

Under the reward system—as with other barter trades—the barter system operator may extract an appropriate commission in either the national or the mutual currency based on the value of the transaction. Typically, the barter system operator takes its commissions in the national currency.

4. Process Flow

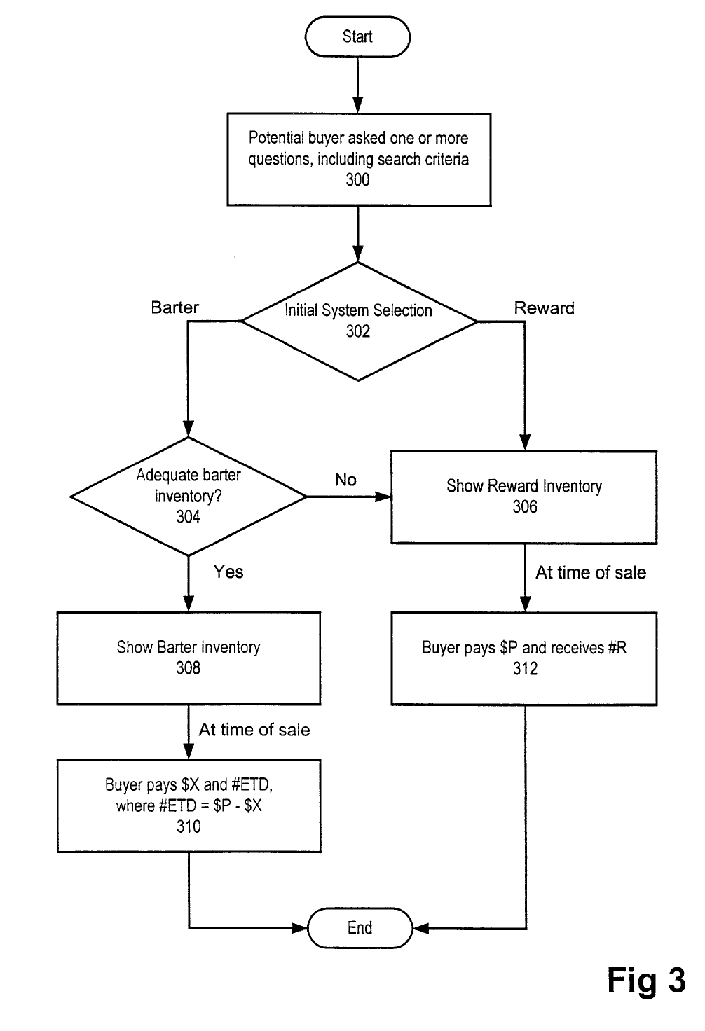

FIG. 2 is a flowchart describing the process for classifying inventory as barter or reward transactions. FIG. 3 is a flowchart describing the inventory availability process provided to buyers using the barter system. The processes of FIGS. 2 and 3 can operate in parallel or in sequence. Further, the inventory classification process of FIG. 2 can be continually run on one or more inventory items as appropriate for re-classification. These processes can be used to minimize the amount of the mutual currency initial participants must hold while also maximizing the availability of inventory to the buyer. First, the process of FIG. 2 for classification of inventory will be described and then the process of FIG. 3 for presenting inventory to buyers will then be described.

The inventory classification process is described in FIG. 2 according to a modified Unified Modeling Language (UML) process flow chart. The process starts at step 200 when inventory is provided to the barter system. This inventory is not the physical inventory, but data corresponding to the inventory, e.g. an entry indicating availability of one or more hotel rooms, a reservation database entry, lot numbers, etc. It is not necessary for the barter system to take physical possession of the inventory—or for the operator of the barter system to do the same. Rather, the barter system operates to maintain the mutual currency and provide a trading exchange for the inventory.

The inventory may come from one or more automated systems such as a reservation system, optionally including a yield management system, an inventory system, an automated listing system, and/or other systems. Also, the inventory can be provided directly by manual entry by a user to a form, e.g. online over the web/email or paper.

At step 200, additional information about the inventory can be provided including a listing price ($P), a minimum amount of the national currency desired ($X), and/or a preference as to whether the item be listed for reward or barter transaction. This information may be provided by the one or more automated systems, e.g. the reservation system, inventory system, etc., or may be manually provided separately from the input of the inventory.

For example, in the travel industry (hotel rooms, rental cars, travel vouchers, plane tickets, train tickets, bus tickets, and other ancillary services), sophisticated yield management systems incorporated into reservation systems may continually adjust the price of an item. Thus, the reservation system can continually use the process of FIG. 2 to update the pricing for a listed item. Thus, for example, the listing price ($P) could be lowered or raised as needed. Similarly, as the departure time arrives, the item could be shifted from reward inventory to barter inventory.

In other instances, e.g. manufacturing, the classification may depend on the type of inventory, e.g. refurbished equipment is bartered, but new equipment is sold in reward transactions.

The actual classification process is collaborative though, with the barter system making the final determination at step 202. This classification process allows the barter system operator to place limits on sellers' options. For example, as shown a system barter/cash ratio maximum (%C) is provided at step 230. For example if %C was 20%, then no more than 20% of each barter transaction could be in the national currency, e.g. $X / $P must be <%C. Additional system driven rules may be used to re-classify inventory, e.g. the balance of the sellers mutual currency account, available #ETD 242, and the size of their line of credit 244 could be factored into the determination at step 202.

Once classified, the inventory is either listed for barter at step 206 or listed for reward at step 212. If the inventory is listed for barter, at step 206 then at the time of sale, the vendor will receive $X in the national currency and her/his available #ETD 242 will increase by $P−$X as shown in step 208. This calculation assumes a fixed 1:1 exchange ratio between the national currency and the mutual currency, floating and non-equal exchange ratios are also permitted.

If the inventory is listed for reward at step 212, the price is computed at step 214. At step 214, historical data 240, e.g. what people have paid for before at what prices as well as past inventory turns, is considered together with the amount of mutual currency available, available #ETD 242, and/or the seller's line of credit 244. The goal of the formula at step 214 is to minimize the available #ETD 242 across all reward inventory—as well as reduce the outstanding line of credit. Additionally, projected demand for the inventory can be used either based on the historical data 240 or from independent projections.

Because the classification of inventory to reward or barter can change over time, the reward computations for other inventory items can also be changed dynamically. Thus, the removal of ten airline tickets from reward inventory to barter inventory by the reservation system in conjunction with the classification process at step 202, might lead to increased rewards for other reward inventory—if appropriate to help minimize the available #ETD 242.

At the time of sale for reward inventory, as shown in step 216, the seller will receive $P in the national currency and the seller will pay the buyer #R in the mutual currency.

A simple example may be helpful. For this example, we will assume that the seller has an available #ETD of #100 and that they have no line of credit 244, or historical data 240. Only a single inventory item will be considered a luxury hotel room with an initial listing price of $P of $400 and a minimum national currency requirement $X of $350 and an initial preference for a reward transaction. At step 202, the inventory would be classified as reward. Note, that even if the seller had preferred barter, if %C was 20%, then $350/$400>>20% so the inventory would have been classified for a reward transaction anyhow.

Next, at step 214, an initial reward is computed, the reward might be #R of #75. Since by assumption, there is no historical data 240 for this seller, this reward may be based on similar inventory as well as a conservative estimate of how many #ETD's the seller may need for future inventory items. Thus, the system does not necessarily attempt to constantly zero the available #ETD 242 with the listed items, but rather attempts to achieve a global minimization of that amount based on inventory turns, demand, pricing constraints, etc. Thus, as more historical data 240 about the seller becomes available, better #R computations can be made. Notice also that #R does not need to relate to $P or $X or their difference, $50. Additionally, #R might even exceed #P in some instances where the reward computation of step 214 so dictates. In some embodiments, the #R might be assigned to liquidate the current available #ETD 242 within a predetermined time period, e.g. before the end of the hour, day, week, month, fiscal year, etc.

Assuming that two days before the reservation night, the luxury hotel room is still not booked, the reservation system might lower the price, e.g. $P of $200, $X of $20, preference for barter. This is not a necessary set of changes, but one selected by the seller with a preference to moving the inventory and getting a sale rather than losing the room. At this new price, the inventory just meets the barter/cash ratio of 20% and is classified as barter at step 202. Most generally, a tolerance around the barter/cash ratio %C 230 can be used. This may cause the re-computation of one or more rewards for other inventory by that seller—of which there is none in this example. The inventory would then be listed for barter at step 206 with the potential buyer needing to pay $20 and #180.

In fact, the reservation system could be continually updating the pricing of an inventory item up until the time of sale. As such the process of FIG. 2 can be run continuously and separately from the process of FIG. 3 to allow for maximum seller pricing flexibility.

The process of presenting inventory to the user will now be described in greater detail with respect to FIG. 3.

First, at step 300 the potential buyer is asked one or more questions. Those questions may include search criteria. The search criteria would designate the particular inventory item that the user needs, e.g. a ticket from Los Angeles to San Francisco on Dec. 25, 1999 in the morning. The questions more generally try to determine the user's purchasing preferences, examples include:

I am willing to take a ticket with significant restrictions on cancellation? (True/False)

I need to fly out on this specific date and time? (True/False)

I would prefer to save some money and get a good computer rather than the newest one off the assembly line? (True/False)

I am willing to purchase refurbished merchandise for steep discounts? (True/False)

Based primarily on the answers to the questions—without respect to the search criteria answers, an initial system selection is made at step 302 between a barter transaction and a reward transaction. Also, the particular screening questions may vary based on the inventory category. Typically two to three screening questions would be used at a time, though individual categories may use fewer or greater numbers.

For example, if the user's answers to a travel related inventory purchase suggest a high degree of flexibility and a willingness to accept restrictions, her/his purchase may be initially categorized for barter. In contrast, a user who indicates she/he needs a specific flight, etc., might be initially categorized for reward.

If the initial selection was for a barter transaction, the search criteria are used at step 304 to determine if there is adequate matching inventory available. If not, the user can be provided reward inventory at step 306—thus overriding the initial selection and ensuring high availability of inventory to the buyer.

If adequate barter inventory exists, the process continues at step 308. At step 308, the user is shown matching barter inventory for her/his search criteria. At the time of sale, she/he will pay $X and #ETD to the buyer as shown in step 310. The #ETD computation can be adjusted depending on the exchange rate between the mutual currency and the national currency.

For reward transactions, at step 306, the user is presented matching reward inventory. At the time of sale, the buyer pays the full listing price $P, but receives #R in the mutual currency from the seller as shown at step 312.

This process provides for high availability of inventory to users—irrespective of their initial question answers that might suggest that barter inventory would be preferred. The screening questions are also desirable because sellers want to sell both their excess (barter) inventory and their full cash (reward) inventory completely. That is to say, the sellers want all airline tickets to be sold—even for barter—especially because they know that the reward process of FIG. 2 will insure that the initial participants are not saddled with large mutual currency balances.

C. Conclusion

In some embodiments, the reward computation and inventory classification processes are implemented as one or more software programs. The software programs may be stored in computer readable medium such as CD-ROMs, floppy diskettes, and/or other computer readable medium. Some embodiments of the invention are included in an electromagnetic wave form. The electromagnetic wave form comprises information such as reward computation and inventory classification programs. The electromagnetic waveform might include the programs accessed over a network.

The foregoing description of various embodiments of the invention has been presented for purposes of illustration and description. It is not intended to limit the invention to the precise forms disclosed. Many modifications and equivalent arrangements will be apparent.

What is claimed is:

1. A method of completing a transaction using a national currency and a mutual currency, the method comprising:
receiving an item to list for sale on a computer, the item having a corresponding seller;
classifying the item as one of for barter and for reward using the computer; and
upon sale of the item to a buyer:
if the item is for barter, using the computer to transfer a first predetermined amount of the national currency from the buyer to the seller of the item and a second predetermined amount of the mutual currency from the buyer to the seller of the item, otherwise
if the item is for reward, using the computer to transfer a third predetermined amount of national currency from the buyer to the seller of the item and a fourth predetermined amount of mutual currency from the seller of the item to the buyer.

2. The method of claim 1, wherein the item has a listing price ($P) specified in the national currency and a minimum amount of national currency desired by the seller ($X) specified in the national currency, and wherein the system has a maximum barter to cash ratio (%C) and wherein, the item is classified for reward if $X/$P>%C.

3. The method of claim 2, wherein there is an exchange ratio (r) between the national currency and the mutual currency, and wherein the item has been classified for barter, and wherein the first predetermined amount is $X and wherein the second predetermined amount #ETD=r($P−$X).

4. The method of claim 1, wherein the item has been classified for reward, and a historical data, an available mutual currency balance of the seller, and a line of credit in the mutual currency of the seller are used to select the fourth predetermined amount (#R) so as to globally minimize the available mutual currency balance of the seller and the line of credit in the mutual currency of the seller over a predetermined period.

5. The method of claim 1, wherein the item has a listing price ($P) and wherein the third predetermined amount is $P if the item is classified for reward.

6. An online barter exchange to support a number of barter transactions between a number of participants in a mutual currency, the online barter exchange comprising:
a web interface to the online barter exchange;
a plurality of cash equivalent inventories for inclusion in the online barter exchange; and
software resources for permitting a barter transaction by at least one participant in the number of participants at least partially in the mutual currency for one or more of the number of cash equivalent inventories.

7. The online barter exchange of claim 6, wherein the software resources also permit the barter transaction to be conducted at least partially in one or more national currencies

8. An online barter exchange system for conducting a transaction using a national currency and a mutual currency, the system comprising:
classification resources for classifying an item as one of for barter and for reward on the online barter exchange, wherein the item is initially owned by a seller; and
resources for transfering via the online barter system a first predetermined amount of the national currency from the buyer to the seller of the item and a second predetermined amount of the mutual currency from the buyer to the seller of the item if the item is for barter;
resources for transferring via the online system a third predetermined amount of national currency from the buyer to the seller of the item and a fourth predetermined amount of mutual currency from the seller of the item to the buyer if the item is for reward.

9. The system of claim 8, wherein the item has a listing price ($P) specified in the national currency and a minimum amount of national currency desired by the seller ($X) specified in the national currency, and wherein the system has a maximum barter to cash ratio (%C) and wherein, the item is classified for reward by the classification resources if $X/$P>%C.

10. The system of claim 8, wherein there is an exchange ratio (r) between the national currency and the mutual currency, and wherein the item has been classified by the classification resources for barter, and wherein the first predetermined amount is $X and wherein the second predetermined amount #ETD=r($P−$X).

11. The system of claim 8, wherein the item has been classified for reward by the classification resources, and a historical data, an available mutual currency balance of the seller, and a line of credit in the mutual currency of the seller are used by the online barter system to select the fourth predetermined amount (#R) so as to globally minimize the available mutual currency balance of the seller and the line of credit in the mutual currency of the seller over a predetermined period.

12. The system of claim 8, wherein the item has a listing price ($P) and wherein the third predetermined amount is $P if the item is classified for reward by the classification resources.
